(19) United States
(12) Patent Application Publication
(10) Pub. No.: US 2006/0206754 A1
(43) Pub. Date: Sep. 14, 2006

(54) Disk array control device, storage system, and method of controlling disk array

(75) Inventor: Shingo Kakui, Inagi-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/371,942

(22) Filed: Mar. 10, 2006

(30) Foreign Application Priority Data
Mar. 11, 2005 (JP) 2005-069887

(51) Int. Cl. G06F 11/00

(52) U.S. Cl. 714/6

(57) ABSTRACT

A disk array control device controls a disk array in accordance with a disk access request from a host device. The disk array control device includes a cipher unit which ciphers write data transmitted from the host device, using a key unique to the disk array control device, a write unit which writes the ciphered write data and redundant data for recovering a fault of the ciphered write data to the disk array, a read unit which reads ciphered data out of the disk array in accordance with a read request from the host device, a decipher unit which deciphers the ciphered data that is read out of the disk array, using the key, and a return unit which returns the deciphered data to the host device.

### CROSS-REFERENCE TO RELATED APPLICATIONS

This application is based upon and claims the benefit of priority from prior Japanese Patent Application No. 2005-069887, filed Mar. 11, 2005, the entire contents of which are incorporated herein by reference.

### BACKGROUND OF THE INVENTION

1. Field of the Invention

The present invention relates to a disk array control device for storing data in a disk array such as a redundant array of inexpensive disks (RAID), a storage system for doing the same, and a method of controlling the disk array.

2. Description of the Related Art

Information processing apparatuses such as server computers and personal computers have recently employed a redundant disk array such as a RAID to improve in disk access speed and protect data stored therein.

In a RAID, some redundant levels (RAID levels) such as RAID1, RAID4 and RAID 5 are defined. In a RAID system, data items and redundant data items for recovering faults of the data items are dispersed and stored in a plurality of disk drives. Thus, the RAID system achieves an adequate fault tolerance. The RAID system has a rebuild function of restoring the contents of data stored in a disk drive that fails, using data stored in another disk drive.

Most personal computers employ a hard disk drive as a storage device and so do audio video (AV) devices. The hard disk drive stores pay Internet contents downloaded from the Internet and broadcast contents such as pay TV broadcast programs.

Some of the above contents are however inhibited from being copied for their backup in terms of copyright protection. If a hard disk drive fails, the purchased contents stored therein will be lost.

Jpn. Pat. Appln. KOKAI Publication No. 2002-351747 discloses a storage system having a function of backing up data that is stored in a storage device such as a hard disk, using a dedicated backup device. In the storage system, data stored in storage area A of the storage device is ciphered by a key unique to the storage area A and then stored in the backup device. Since, however, the storage system requires the backup device exclusively for storing the ciphered data, its costs will be increased.

If a RAID system is simply used to store copy-protected contents, there is fear that the contents will be copied illicitly. In a RAID1 system having two disk drives to which the same data is written, there is fear that one of the disk drives will be detached from the system and data stored in the detached disk drive will be used in another device illicitly. In RAID4 and RAIDS systems, too, there is fear that the contents stored in each individual disk drive will be copied illicitly by the rebuild function described above.

### BRIEF SUMMARY OF THE INVENTION

According to an embodiment of the present invention, there is provided a disk array control device that controls a disk array in accordance with a disk access request from a host device, comprising a cipher unit which ciphers write data transmitted from the host device, using a key unique to the disk array control device, a write unit which writes the ciphered write data and redundant data for recovering a fault of the ciphered write data to the disk array, a read unit which reads ciphered data out of the disk array in accordance with a read request from the host device, a decipher unit which deciphers the ciphered data that is read out of the disk array, using the key, and a return unit which returns the deciphered data to the host device.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a configuration of a storage system according to an embodiment of the present invention;

FIG. 2 is a diagram of a data storage form in the storage system shown in FIG. 1;

FIG. 3 is a diagram of another data storage form in the storage system shown in FIG. 1;

FIG. 4 is a chart of a flow of data to be written in the storage system shown in FIG. 1;

FIG. 5 is a flowchart of a write process executed by a RAID controller provided in the storage system shown in FIG. 1;

FIG. 6 is a chart of a flow of data to be read in the storage system shown in FIG. 1; and

FIG. 7 is a flowchart of a read process executed by the RAID controller provided in the storage system shown in FIG. 1.

### DETAILED DESCRIPTION OF THE INVENTION

An embodiment of the present invention will be described with reference to the accompanying drawings.

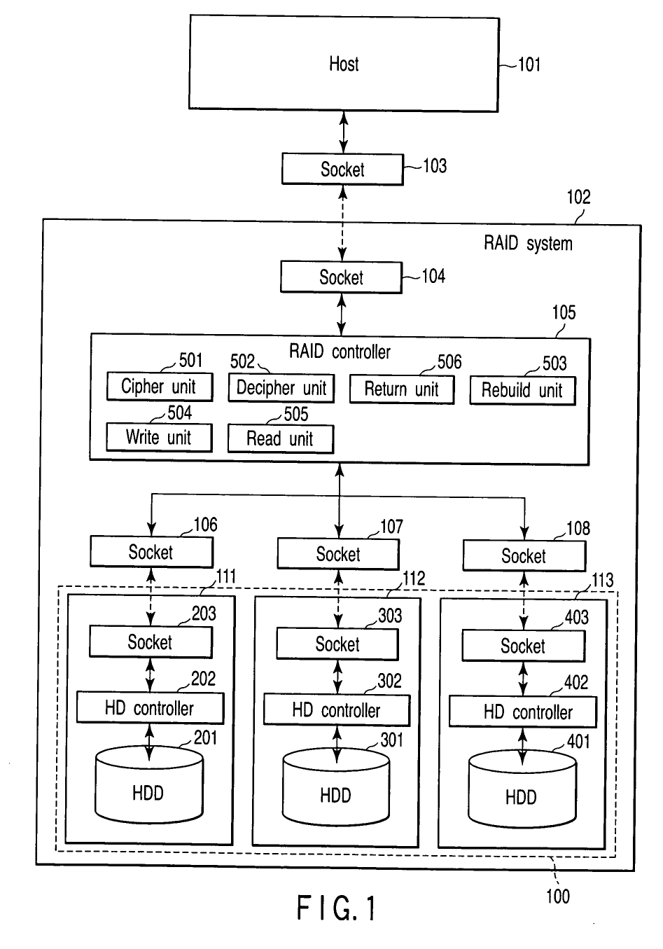

FIG. 1 shows a configuration of a storage system 102 according to the embodiment of the present invention. The storage system 102 stores data that is processed by a host device 101 such as a personal computer, a TV set and an AV device. The storage system 102 is implemented as a redundant array of inexpensive disks (RAID) system wherein data items and redundant data items for recovering faults of the data items are dispersed and stored in a disk array 100. The storage system 102 is also implemented as a storage device built in the host device 101 or a storage device externally attached to the host device 101.

The storage system 102 is detachably connected to a connection unit (socket) 103 that is provided for the host device 101. Referring to FIG. 1, the storage system 102 includes a socket 104, a RAID controller 105, sockets 106 to 108, and a plurality of disk drives 111 to 113.

The socket 104 has the same shape as that of the socket 103 and serves to connect the storage system 102 with the host device 101. The RAID controller 105 is a disk array control device for controlling a disk array 100 including the disk drives 111 to 113, in accordance with a disk access request from the host device 101. The RAID controller 105 controls the disk drives 111 to 113 such that they serve as redundant disk arrays such as RAID1, RAID4 and RAID5. The RAID controller 105 includes a cipher unit 501, a decipher unit 502, a rebuild unit 503, a write unit 504, a read unit 505 and a data return unit 506.

The cipher unit 501 ciphers write data transmitted from the host device 101 using a key unique to the RAID controller 105. The write unit 504 writes both the ciphered write data and redundant data for recovering a fault of the ciphered write data to the disk array 100 including the disk drives 111 to 113. The read unit 505 reads the ciphered data out of the disk array 100, in accordance with a read request from the host device 101. The decipher unit 502 deciphers the ciphered data that is read out of the disk array 100, using the above-described key. The data return unit 506 returns the deciphered data to the host device 101. The rebuild unit 503 rebuilds the contents of data stored in a disk drive that fails, using the contents of data stored in another disk drive.

The disk drives 111 to 113 are detachably connected to the sockets 106 to 108, respectively. Each of the sockets 106 to 108 has the same shape as that of the socket 103. Therefore, a user of the host device 101 can connect a normal disk drive to the socket 103 instead of connecting the storage system 102.

The disk drives 111 to 113 are each implemented as a magnetic disk drive (hard disk drive) having an interface such as integrated drive electronics (IDE), small computer system interface (SCSI) and universal serial bus (USB). The disk drive 111 includes a hard disk drive unit (HDD) 201, a hard disk controller (HD controller) 202 and a socket 203. Similarly, the disk drive 112 includes a hard disk drive unit (HDD) 301, a hard disk controller (HD controller) 302 and a socket 303. The disk drive 113 includes a hard disk drive unit (HDD) 401, a hard disk controller (HD controller) 402 and a socket 403.

An example of a data storage form used in the storage system 102 will be described.

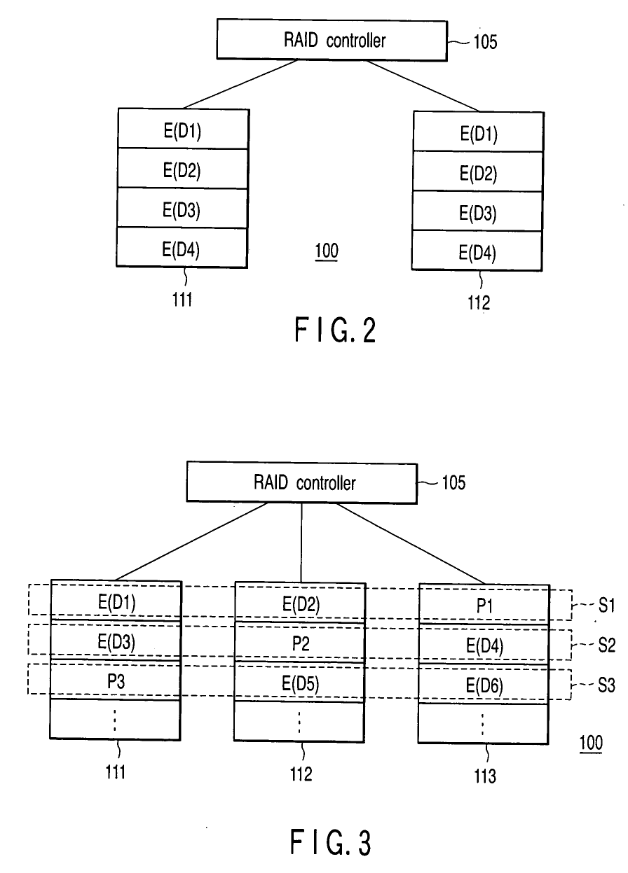

FIG. 2 illustrates a disk array 100 of the RAID1. This disk array 100 includes two mirroring disk drives 111 and 112. The RAID controller 105 ciphers write data D1 transmitted from the host device 101, stores the ciphered write data E (D1) in the disk drive 111, and stores the same data (duplicate data) as the ciphered write data E (D1) in the disk drive 112 as redundant data for recovering a fault of the write data E (D1). The disk drives 111 and 112 are therefore identical in data structure with each other, as illustrated in FIG. 2. In other words, the contents stored in the disk drive 112 are identical with those stored in the disk drive 111.

Even though one of the disk drives 111 and 112 fails, correct data can be read out of the other disk drive. The disk array 100 of the RAID1 can be implemented by two or more even-numbered disk drives.

FIG. 3 illustrates a disk array 100 of the RAIDS. This disk array includes three disk drives 111, 112 and 113 that are striped by a plurality of stripes. Each of the stripes has parity P as redundant data. In other words, each of the stripes includes a plurality of data blocks and parity generated from the data blocks.

In FIG. 3, stripe S1 includes two data blocks (ciphered data E(D1) stored in the disk drive 111 and ciphered data E(D2) stored in the disk drive 112) and parity P1 stored in the disk drive 113. The parity P1 is generated from the two data blocks, or the ciphered data E(D1) and ciphered data E(D2), and used to recover their faults. Stripe S2 includes ciphered data E(D3) stored in the disk drive 111, parity P2 stored in the disk drive 112 and ciphered data E(D4) stored in the disk drive 113. The parity P2 is generated from two data blocks, or the ciphered data E(D3) and ciphered data E(D4), and used to recover their faults. Stripe S3 includes parity P3 stored in the disk drive 111, ciphered data E(D5) stored in the disk drive 112 and ciphered data E(D6) stored in the disk drive 113. The parity P3 is generated from two data blocks, or the ciphered data E(D5) and ciphered data E(D6), and used to recover their faults.

Assume now that write data D1 and write data D2 are written from the host device 101 to the disk array 100 of the RAID 5. The RAID controller 105 ciphers each of the write data D1 and write data D2 transmitted from the host device 101. Then, the RAID controller 105 stores the ciphered data E(D1) and ciphered data E(D2) in the disk drives 111 and 112, respectively and stores parity Pi corresponding to the ciphered data E(D1) and ciphered data E(D2) in the disk drive 113.

When one of the three disk drives 111 to 113 fails, its stored contents can be reconstructed from those of the other two disk drives. Assuming here that the disk drive 112 fails, the ciphered data E(D2) can be reconstructed from the other data (the ciphered data E(D1) and parity P1) in the stripe S1 to which the ciphered data E(D2) belongs. Similarly, the ciphered data E(D5) can be reconstructed from the other data (the parity P3 and ciphered data E(D6)) in the stripe S3 to which the ciphered data E(D5) belongs.

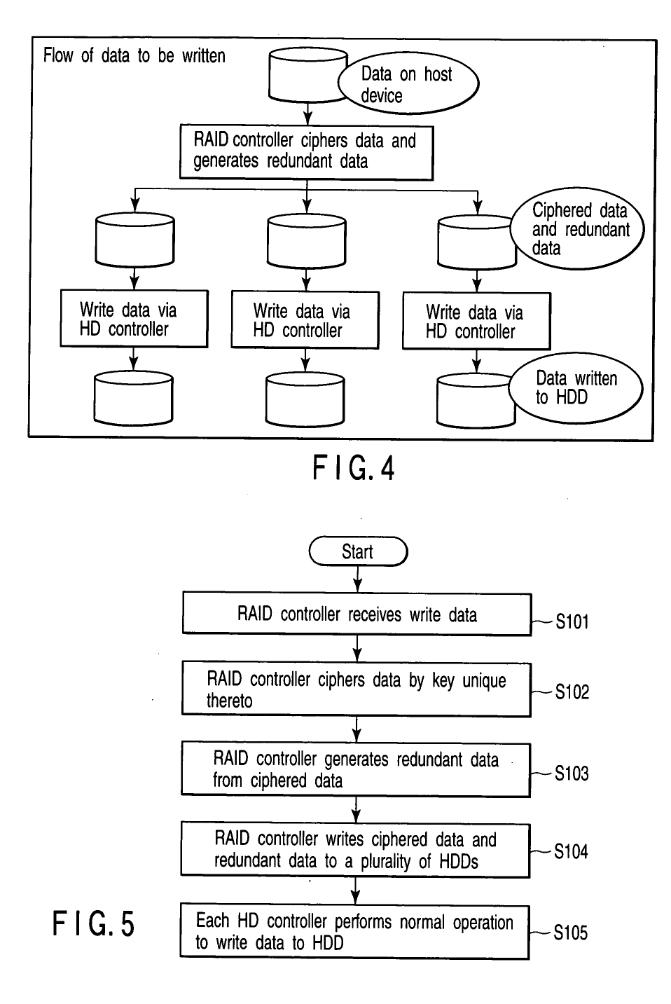

A process of writing data to a disk array 100 will be described with reference to FIGS. 4 and 5. FIG. 4 shows a flow of write data to be written to a disk array 100 from the host device 101. FIG. 5 shows a write process to be executed by the RAID controller 105.

The RAID controller 105 receives a data write request from the host device 101 (step S101). This request includes write data and a logical address indicating an address to which the data is written.

The RAID controller 105 ciphers the write data transmitted from the host device 101 by a key unique to the RAID controller 105 (step S102). The key is stored in advance in a nonvolatile memory, such as a ROM, in the RAID controller 105.

Then, the RAID controller 105 generates redundant data (duplicate data of the ciphered write data or parity corresponding to a stripe to which the ciphered write data belongs) to recover a fault of the ciphered write data (step S103). The RAID controller 105 performs a process of dispersing and writing the ciphered write data and the redundant data to a plurality of disk drives (steps S104 and S105). In step S105, a normal write operation is performed for each of the disk drives. In other words, the write data and redundant data are written to the hard disk drive unit (HDD) in each of the disk drives upon receipt of a write request from the RAID controller 105.

As described above, a data stream such as pay contents transmitted from the host device 101 as write data is stored in a disk array with the data structure shown in FIG. 2 or FIG. 3.

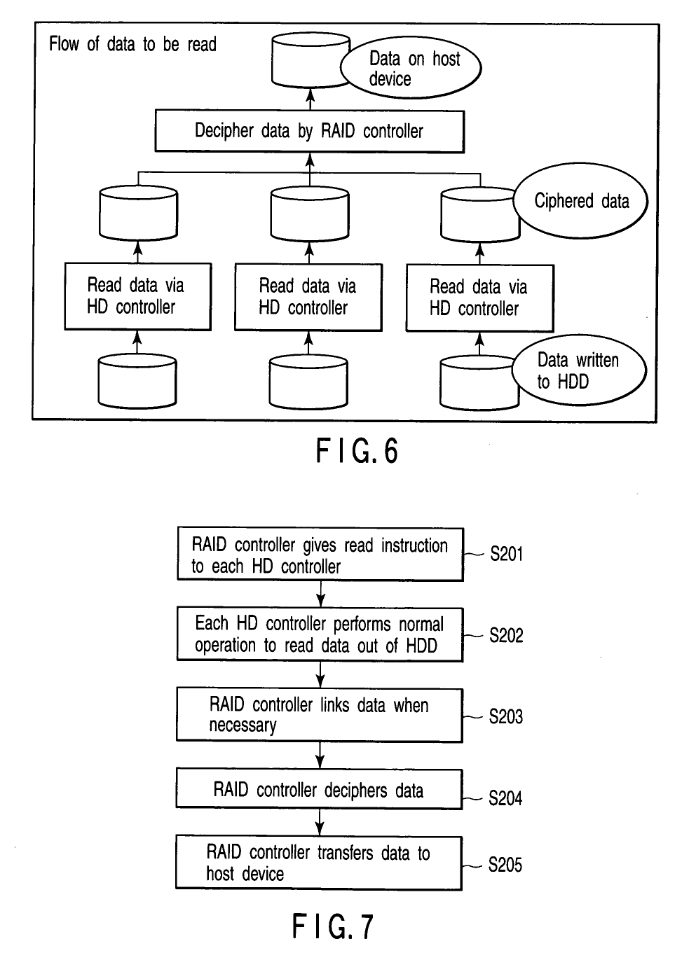

A process of reading data out of the disk array 100 will be described with reference to FIGS. 6 and 7.

FIG. 6 shows a flow of data to be read out of a disk array by the host device 101. FIG. 7 shows a read process executed by the RAID controller 105.

The RAID controller 105 receives a data read request from the host device 101. This request includes a logical address indicating an address from which the data is read and a data size of the data. The RAID controller 105 issues a read instruction to a hard disk controller in a required disk drive and reads the ciphered data designated by the data read request from the host device 101 (steps S201 and S202).

The RAID controller 105 links ciphered data items, which are read out of a plurality of disk drives that configure a disk array 100, when the need arises (step S203) and then deciphers the ciphered data by the key unique to the RAID controller 105 (step S204). Then, the RAID controller 105 returns the deciphered data to the host device 101 (step S205).

In the storage system 102, the data stored in the disk array 100 is ciphered by a key unique to the RAID controller 105. Thus, the data stored in each of the disk drives that configure the disk array 100 cannot be reproduced normally unless the data is read out through the disk array controller 105 of the storage system 102. Since the RAID system achieves an adequate fault tolerance, the copy-protected contents such as pay contents can be protected from a danger that they will be lost due to a fault of a hard disk, without backing them up in other storage media.

In the present embodiment, only the RAID1 and RAID5 have been described. However, RAID4 can be applied to the embodiment.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A disk array control device that controls a disk array in accordance with a disk access request from a host device, comprising:
a cipher unit which ciphers write data transmitted from the host device, using a key unique to the disk array control device;
a write unit which writes the ciphered write data and redundant data for recovering a fault of the ciphered write data to the disk array;
a read unit which reads ciphered data out of the disk array in accordance with a read request from the host device;
a decipher unit which deciphers the ciphered data that is read out of the disk array, using the key; and
a return unit which returns the deciphered data to the host device.

2. The disk array control device according to claim 1, wherein the disk array includes at least two mirroring disk drives.

3. The disk array control device according to claim 1, wherein the disk array includes a plurality of disk drives being striped by a plurality of stripes each having a plurality of data blocks and parity generated from the data blocks.

4. The disk array control device according to claim 1, wherein the disk array includes a plurality of disk drives each configured by a magnetic disk drive.

5. A storage system that stores data to be processed by a host device, comprising:
a disk array; and
a disk array control device including a cipher unit which ciphers write data transmitted from the host device, using a key unique to the disk array control device, a write unit which writes the ciphered write data and redundant data for recovering a fault of the ciphered write data to the disk array, a read unit which reads ciphered data out of the disk array in accordance with a read request from the host device, a decipher unit which deciphers the ciphered data that is read out of the disk array, using the key, and a return unit which returns the deciphered data to the host device.

6. The storage system according to claim 5, wherein the disk array includes at least two mirroring disk drives.

7. The storage system according to claim 5, wherein the disk array includes a plurality of disk drives being striped by a plurality of stripes each having a plurality of data blocks and parity generated from the data blocks.

8. The storage system according to claim 5, wherein the disk array includes a plurality of disk drives that are detachably connected to the storage system.

9. A method of controlling a disk array by a disk array control device, comprising:
ciphering write data transmitted to the disk array control device from the host device, using a key unique to the disk array control device;
writing the ciphered write data and redundant data for recovering a fault of the ciphered write data to the disk array;
reading ciphered data out of the disk array in accordance with a read request transmitted to the disk array control device from the host device;
deciphering the ciphered data that is read out of the disk array, using the key; and
returning the deciphered data to the host device from the disk array control unit.

10. The method according to claim 9, wherein the disk array includes at least two mirroring disk drives.

11. The method according to claim 9, wherein the disk array includes a plurality of disk drives being striped by a plurality of stripes each having a plurality of data blocks and parity generated from the data blocks.
